(19) United States
(12) Patent Application Publication
(10) Pub. No.: US 2004/0255566 A1
(43) Pub. Date: Dec. 23, 2004

(54) Hay conditioner

(76) Inventors: Laurence Colin Phillips, Western Australia (AU); Geoffrey Robert Castlemain, Western Australia (AU)

Correspondence Address: HARNESS, DICKEY & PIERCE, P.L.C., P.O.BOX 8910, RESTON, VA, 20195, US

(21) Appl. No.: 10/483,669

(22) PCT Filed: Jul. 15, 2002
(86) PCT No.: PCT/AU02/00951

(30) Foreign Application Priority Data
Jul. 13, 2001 (AU) PR 6383

(51) Int. Cl. A01D 61/00

(52) U.S. Cl. 56/16.4 R

(57) ABSTRACT

Apparatus for conditioning plant material in the production of hay. The apparatus comprises a conditioning part (12) through which plant material can be passed to be subjected to compression for fracturing the stalks thereof. The conditioning path (12) has an intake end (21) and a discharge end (23). The conditioning path (12) is defined between two compression surfaces (26, 28), one of which is defined by an endless beam (25) moveable through a cyclic path about rollers (31, 32). The rollers (31, 32) are mounted on a common support (33). The compression surfaces (26, 28) are arranged for movement with respect to each other for varying the size of the intake end (21) relative to the discharge end (23). Typically, the common support (33) for the rollers (31, 32) comprises a beam (33) which is angularly moveable, and wherein control means (43) are provided for controlling angular movement of the beam (33).

### FIELD OF THE INVENTION

This invention relates to apparatus for conditioning plant material. The invention has been devised particularly for the conditioning of plant material in the production of hay.

### BACKGROUND ART

Traditionally, plant material used to make hay is cut with a mower and left on the ground to dry before being baled and removed for storage. The drying process creates a risk that rain could ruin the cut material lying on the ground. It is therefore common to enhance the drying process by passing the hay through a conditioner. The conditioner crimps the stalks of the plant material to bleed the material and promote faster drying.

One known form of hay conditioner comprises two rollers between which the plant material is compressed to perform the crimping action. Typically one or both of the rollers are provided with grooves or ribs which contact the plant material and fracture it as it passes between the rollers.

A new term, “superconditioning” used in the industry describes a process whereby plant material is passed between two plain rollers. These rollers are often steel on steel, or sometimes coated with rubber or polyurethane.

Superconditioning flattens the stalk and splits the stalk over most or all of its length, thereby speeding up the drying process even more. It is desirable when splitting the plant stalk to also crack open the nodes of the plant.

Rollers used in this process must travel at high speed to handle the volume of plant material being processed.

When the plant material enters the compression zone between the two rollers, the result is instantaneous. As a consequence, large shock loads are present. These shock loads have an effect on the machine structure, and also on the plant structure to the point where damage to the plant material can be excessive.

It is against this background and the problems and deficiencies associated herewith, that the present invention has been developed.

### DISCLOSURE OF THE INVENTION

The present invention provides apparatus for conditioning plant material comprising a conditioning path through which plant material can be passed to be subjected to compression for fracturing the stalks thereof, the conditioning path having an intake end and a discharge end, the conditioning path being defined between two compression surfaces one of which is defined by an endless belt moveable through a cyclic path about rollers, the rollers being mounted on a common support, one compression surface being mounted for movement with respect to the other compression surface for varying the size of the intake end relative to the discharge end.

With this arrangement, the bight of the intake end can be adjusted to readily accept plant material which is progressively subjected to increasing compression as it approaches the discharge end.

Preferably, the common support for the rollers comprises a beam which is angularly moveable, with control means being provided for controlling angular movement of the beam.

The other compression surface may be defined by means supported on a further beam.

The control means may be operably connected between the two beams.

The control means may comprise a power device such as a hydraulic cylinder or a pneumatic cylinder. The hydraulic or pneumatic cylinder may be adapted for yielding movement in response to a predetermined load being subjected thereto.

Where a hydraulic cylinder is utilised, it may be incorporated in a hydraulic circuit which includes an accumulator.

Preferably, a drive means is provided for driving the endless belt.

In one arrangement, the other compression surface is defined by a roller.

In another arrangement, the other compression surface may be defined by a second endless belt moveable through a cyclic path about further rollers.

The roller or second endless belt defining the other compression surface may be driven through frictional engagement with the first mentioned endless belt or there may be a drive means provided for that purpose.

Each endless belt may be movable around two end rollers and an intermediate roller, the intake end of the conditioning path being defined adjacent the two intermediate rollers, and wherein there may be an intake zone leading to the intake end of the conditioning path, the intake zone being defined between the runs of the respective endless belts extending between the end rollers adjacent the intake end and the intermediate rollers The intake zone preferably tapers inwardly in the direction towards the intake end.

### BRIEF DESCRIPTION OF THE DRAWINGS

The invention will be better understood by reference to the following description of several specific embodiments thereof as shown in the accompanying drawings in which:

FIG. 1 is a plan view of apparatus according to a first embodiment;

FIG. 2 is an end elevational view of the apparatus of FIG. 1;

FIG. 3 is a view illustrating the structure providing the conditioning path of the apparatus of the first embodiment;

FIG. 4 is a schematic view of a structure providing the conditioning path of an apparatus according to a second embodiment,

FIG. 5 is a schematic view of a structure providing the conditioning path of an apparatus according to a third embodiment;

FIG. 6 is a schematic view of a structure providing a conditioning path according to a fourth embodiment;

FIG. 7 is a schematic view of apparatus according to a fifth embodiment;

FIG. 8 is a schematic view of a structure providing the conditioning path of an apparatus according to a sixth embodiment;

FIG. 9 is a plan view of apparatus according to a seventh embodiment; and

FIG. 10 is an end elevational view of apparatus shown in FIG. 9.

### Best Mode(s) for Carrying Out the Invention

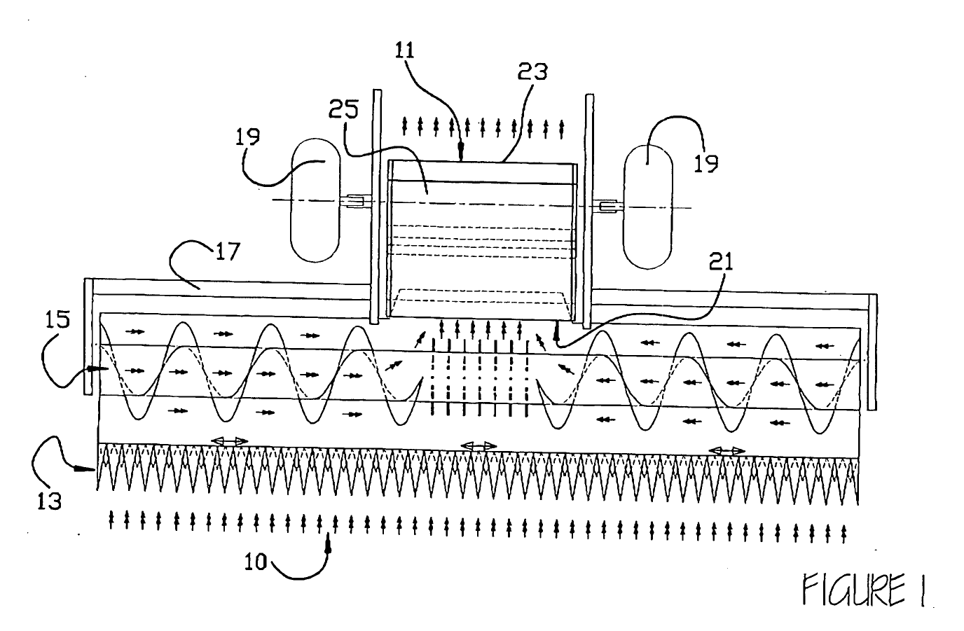

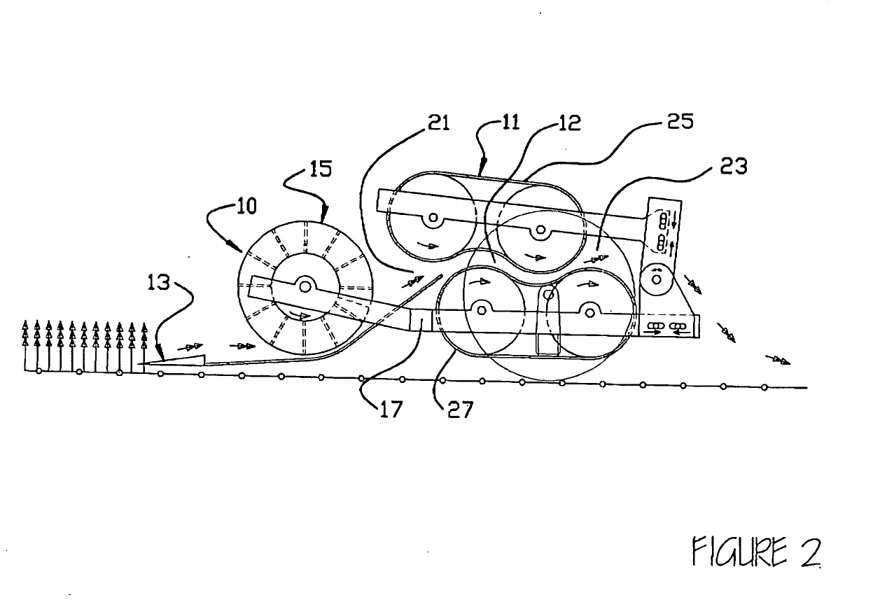

Referring now to FIGS. 1, 2 and 3 of the accompanying drawings, there is shown apparatus 10 for super-conditioning hay. The apparatus 10 is in the form of a mower conditioner and includes a conditioner 11 defining a conditioning path 12 through which hay is passed and in which the hay is subjected to compression for fracturing the hay stalks for conditioning purposes.

The apparatus 10 further includes a mower 13 for cutting plant material for the production of hay, and an elevator assembly 15 for conveying plant material cut by the mower 13 to the conditioning path 12.

The apparatus 10 also includes a frame structure 17 carried on ground wheels 19.

The conditioning path 12 has an intake end 21 and a discharge end 23. Plant material cut by the mower 13 is delivered by the elevator assembly 15 to the intake end 21 of the conditioning path 12.

The conditioning path 12 is defined between an upper endless belt 25 and a lower endless belt 27.

The upper belt 25 has a lower run 26, and the lower belt 27 has an upper run 28, with the conditioning path 12 being defined between the two runs 26, 28, as will be described in more detail below.

The upper belt 25 passes around two upper end rollers 31, 32 each rotatably mounted between two upper support beams 33 (only one of which is seen in the drawings). Similarly, the lower belt 27 passes around two lower end rollers 35, 36 each of which is supported between two lower support beams 37 (only one of which is seen in the drawings). In this embodiment, the lower support beams 37 form part of the frame structure 17.

A drive means (not shown) is provided for driving at least one of the endless belts 25, 27. In this embodiment, one endless belt is directly driven and the other endless belt is indirectly driven through frictional transmission from the directly-driven endless belt. It should, however, be appreciated that both endless belts could be directly driven. Where there is direct drive to one or both endless belts, the drive is through at least one of the rollers about which the respective belt passes.

The two endless belts 25, 27 are driven in opposed directions such that the lower run 26 of the upper belt 25 and the upper run 28 of the lower belt 27 travel from the intake end 21 to the discharge end 23. In this way, plant material delivered to the conditioning path 12 at the intake end 21 is conveyed along the conditioning path and discharged through the discharge end 23.

Each upper team 33 is mounted for angular movement with respect to the adjacent lower beam 37 by way of a connection 41.

A control mechanism 43 is operable to effect angular movement of each upper beam 33 with respect to the adjacent lower beam 37 about the connection system 41. In this embodiment, the control means 43 comprises two hydraulic cylinders 45, each connected between one upper beam 33 and the adjacent lower beam 37. The hydraulic cylinders 45 are incorporated in a common hydraulic circuit (not shown) and operate in unison. With this arrangement, extension of the hydraulic cylinders 45 causes angular movement of the upper beams 33 away from the lower beams 37, and contraction of the hydraulic cylinders 45 causes angular movement of the upper beams 33 towards the lower beams 37. The common hydraulic circuit in which the hydraulic cylinders 45 are incorporated also incorporates an accumulator. The presence of the accumulator allows the hydraulic cylinders 45 to yield to accommodate shock loadings. In this way, the hydraulic cylinders 45 can yield to allow the upper beams 33 to move angularly to accommodate obstacles such as rocks and other oversize material which might happen to enter the conditioning path 12.

Angular movement of the upper beams 33 with respect to the lower beams 37 varies the compressive loading between the runs 26, 28 of the belt, and also varies the size of the intake end 21 with respect to the discharge end 23, as will be explained in more detail later.

Each connection 41 includes a pivot connection 51 which permits pivotal movement of the respective upper beam 33 in relation to the respective lower beam 37. The connection 41 also includes two slotted links 53, 54. The slotted link 53 which permits limited displacement of the upper beam 33 towards and way from the lower beam 37 at the end thereof adjacent the connection 41. An adjustment mechanism (not shown) such as a screw jack mechanism is provided to control such displacement for regulating the compression force exerted between the belt runs 26, 28. The slotted link 54 permits limited axial movement of the upper beam 33 with respect to the lower beam 37, This facilitates adjustment of the relative position of the upper rollers 31, 32 with respect to the lower rollers 35, 36.

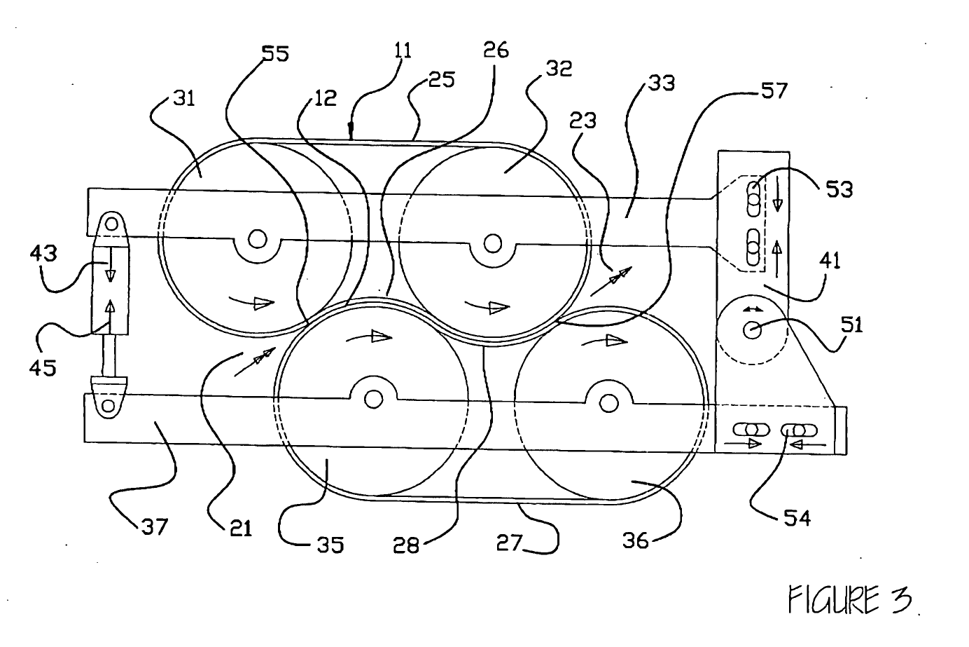

As is seen in FIG. 3 of the drawings, the rollers 31, 32 are so positioned in relation to the rollers 35, 36 that the roller 32 is nestled between the lower rollers 35, 36, and the roller 35 is nestled between the upper rollers 31, 32. With this arrangement, the lower run 26 of the upper belt 25 and the upper run 28 of the lower belt 27 are in mutual contact from point 55 at or near the intersection with a line extending between the centres of the rollers 31 and 35 to point 57 at or near the intersection with a line extending between the centres of the rollers 32 and 36.

The geometry of the connections 41 between the upper beams 33 and the lower beams 37 is such that the compressive force between the belts 25, 27 at the intake end 21 is less than the compressive force between the belts 25, 27 at the discharge end 23. This arrangement facilitates an “easy entry” of plant material into the conditioning path 12 through the intake end 21, with the plant material being subjected to higher compression loadings downstream along the conditioning path 12 before discharging from the conditioning path at the discharge end 23. In this embodiment, it is likely that the highest compression loadings applied to the plant material will be in the stage of the conditioning path 12 immediately proceeding the discharge end 23.

While the compressive forces applied to the plant material does vary along the conditioning path 12, there is nevertheless an extended duration during which the plant material is subjected to compression for conditioning purposes as it travels from the intake end 21 to the discharge end 23.

A particular feature of the embodiment is that the extent of loading can be varied by operation of the hydraulic rams 45. Because of the geometry associated with the beam structures 33, 37, any variation in the size of the intake end 21 is significantly greater than any variation in the size of the discharge end 23.

Loading can also be varied by operation of the adjustment mechanism (not shown) associated with the slotted link 53.

In operation, plant material entering the conditioning path 12 is subjected to compression to fracture the stalks longitudinally and to squeeze juices from the plant material thereof as it travels along the conditioning path before being discharged at the discharge end 23. The plant material has a relatively easy entry at the intake end 21 and is subjected to higher compressive loadings further along the path 11. With this arrangement, shock loadings on the apparatus 10, as well as on the plant material, are avoided. The plant material has an easy entry and is progressively squeezed as it progresses along the path 12, with it being subjected to a final squeeze between rollers 32, 36 before departure via the discharge end 23. The size of the intake end 21 can be selectively regulated as necessary by operation of the control means 43 to vary angular movement of the upper support beams 33 with respect to the lower support beams 37.

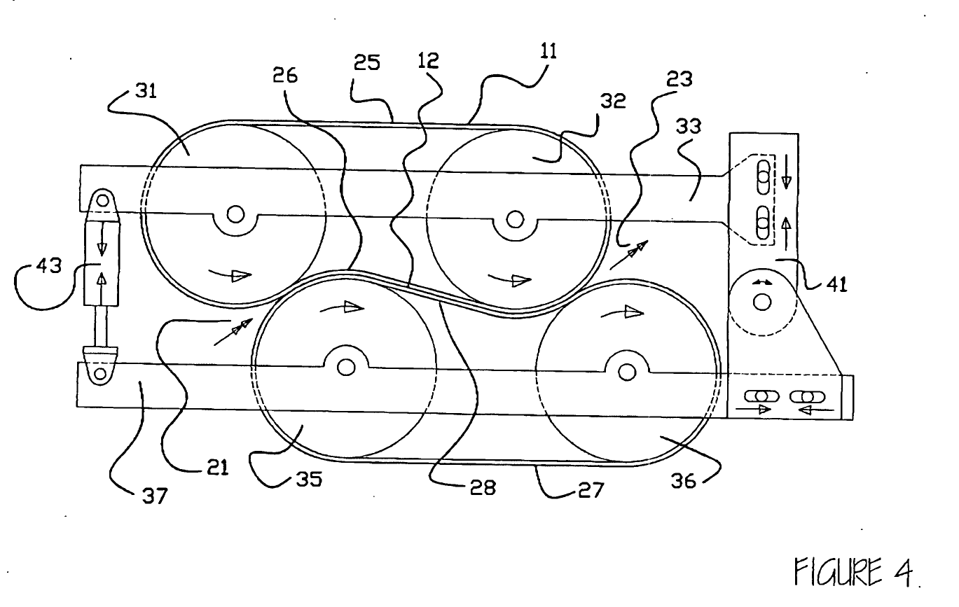

The embodiment shown in FIG. 4 of the drawings is somewhat similar to the first embodiment, with the exception of the relative positions of the upper rollers 31, 32 and lower rollers 35, 36. In the first embodiment, the upper roller 32 was nestled between the two lower rollers 35, 36 and essentially in contact with the lower rollers through the two endless belts 25, 27. Similarly, the lower roller 35 was nestled between the two upper rollers 31, 32 and essentially in contact with them through the two endless belts 25, 27. In the embodiment shown in FIG. 4, the lower roller 35 is only in contact with the upper roller 31 through the two belts 25, 27, and the upper roller 32 is only in contact with the lower roller 36 through the two belts.

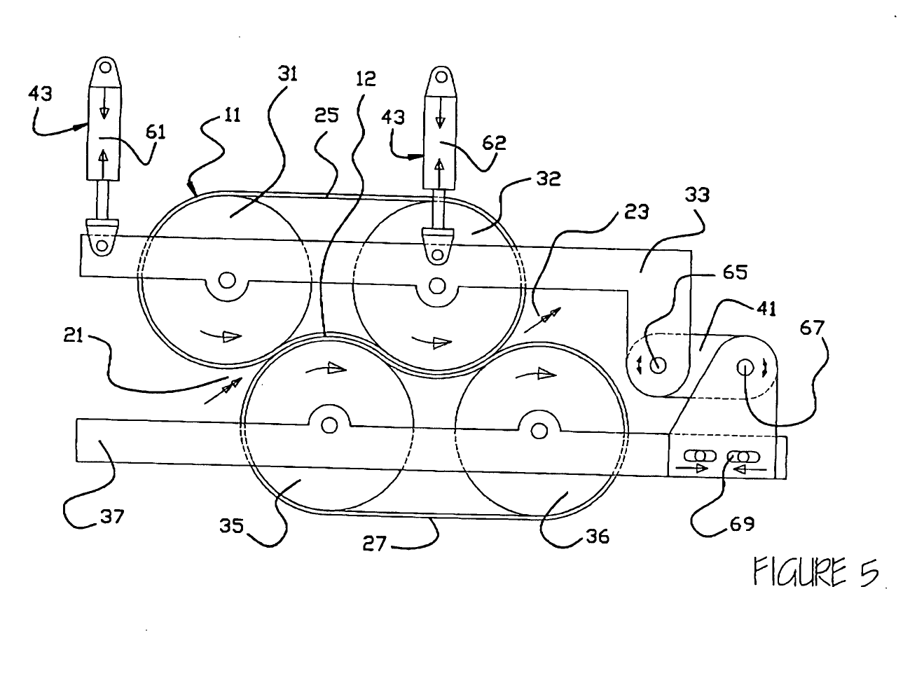

The embodiment shown in FIG. 5 is also somewhat similar to the first embodiment, with the exception that the control means 43 comprises two hydraulic cylinders 61, 62 associated with each upper beam 33. Each hydraulic cylinder 61 is positioned adjacent the free end of the respective upper beam 33, and each hydraulic cylinder 62 is positioned intermediate the ends of the respective upper beam 33 and in close proximity to the axis of the roller 32. With this arrangement, cylinders 62 can exert a significant downward force on the roller 32, and cylinders 61 can raise or lower the roller 31 with little effort. This is because the outer end section of each upper beam 33 opposite the connection 41 can deflect about the axis of roller 32 rather than the entire beam 33 pivoting.

In this embodiment, each connection 41 is a free-moving connection comprising two pivot connections 65, 67 and a slotted link 69. The two pivot connections 65, 67 allow angular movement of the respective upper support beam 33 relative to the lower support beam 37, as well as limited displacement of the upper beam 33 towards and away from the lower beam 37. The slotted link 69 allows limited axial movement of the upper support beam 33 with respect to the lower support beam 37.

The extent of loading within the conditioning path can be selectively varied by appropriate operation of the hydraulic cylinders 61, 62. The free-moving connection 41 allows the hydraulic cylinders 61, 62 on each upper support beam 33 to independently control movement of the upper support beam 33. In other words, each hydraulic cylinder 61, 62 is operable to control angular movement of the respective upper beam in its own particular way. This allows the compressive loading exerted on plant material passing along the conditioning path 12 to be selectively controlled and regulated by appropriate operation of one or both of the hydraulic cylinders 61, 62 on each upper support beam 33.

In another embodiment, the two hydraulic 61, 62 in the previous embodiment may be replaced by other suitable power devices.

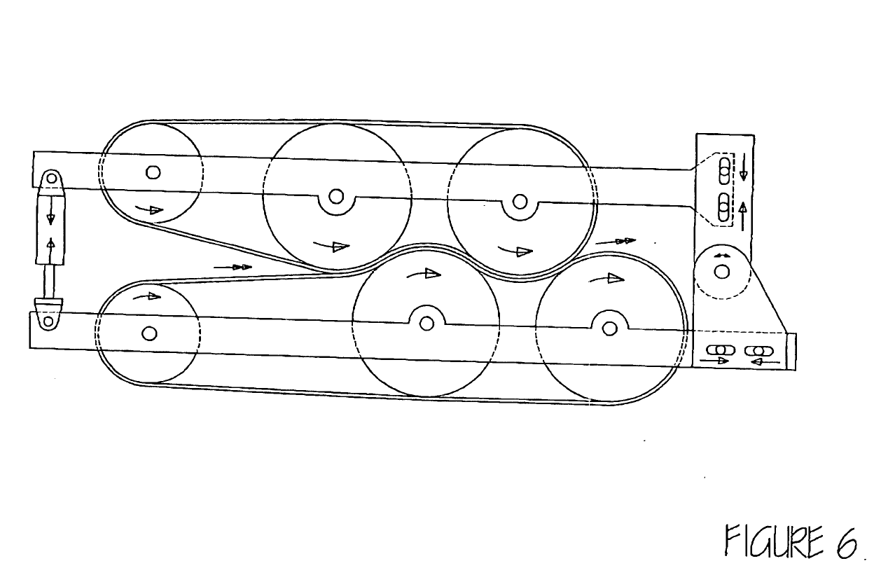

In the embodiments described previously, the upper belt 25 and the lower belt 27 each pass around two rollers. Other arrangements are, of course, possible. One such other arrangement is illustrated in FIG. 6 of the drawings where each endless belt 25, 27 passes around three rollers. Specifically, the upper belt 25 passes around the two upper rollers 31, 32, as well as a third upper roller 34. The rollers 34, 32 provide end rollers for the circuitous path of the upper belt 25, and roller 31 is an intermediate roller. Similarly, the lower belt 27 passes around the two lower rollers 35, 36, as well as a third lower roller 38. The rollers 38, 36 provide end rollers for the circuitous path of the lower belt 27, and roller 35 is an intermediate roller.

The third rollers 34, 38 are adjacent the intake end 21 of the conditioning path 12.

Additionally, the third rollers 34, 38 are in a spaced apart relationship such that an extended intake zone 22 is provided at the intake end 21 of the conditioning path 12.

The extended intake zone 22 is defined between the run 29 of the upper belt 25 extending from the third upper roller 34 and the intermediate upper roller 31, and the run 30 of the lower belt 27 extending from the third lower roller 38 and the intermediate lower roller 35.

The extended intake zone 22 is configured to progressively taper inwardly in the direction towards the intake end 21, The inward tapering of the intake zone 22 is achieved by having the third rollers 34, 38 in spaced apart relation with each other and of smaller diameter than the intermediate rollers 31, 35.

An advantage of the extended intake zone 22 is the flexible nature of the walls thereof defined by the belt runs 29, 30. The flexibility assists in delivering hay to the intake end 21 of the conditioning path 12 in a gentle fashion.

The rollers 31, 32 are so positioned in relation to the rollers 35, 36 that the roller 32 is nestled between the lower rollers 35, 36, and the roller 35 is nestled between the upper rollers 31, 32. With this arrangement, the lower run 26 of the upper belt 25 and the upper run 28 of the lower belt 27 are in mutual contact from a point at or near a intersection with a line extending between the centres of the rollers 31 and 35 to a point at or near the intersection with a line extending between the centres of the rollers 32 and 36.

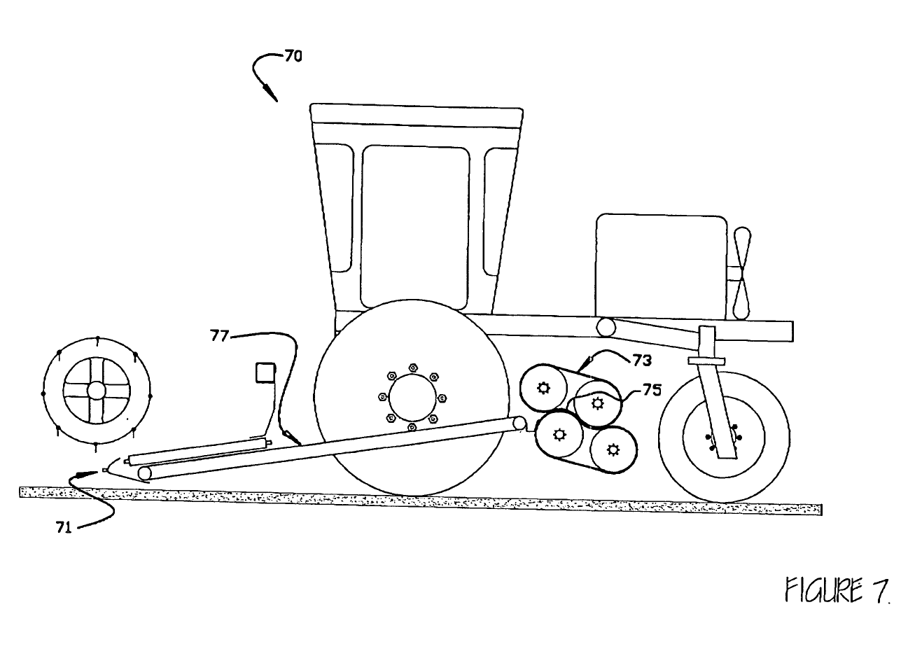

Referring now to FIG. 7 there is shown apparatus 70 according to a still further embodiment. The apparatus 70 is somewhat similar to the apparatus 10 in the sense that it is in the form of a mower conditioner. The apparatus 70 includes a mower 71 for cutting plant material for production of hay, a conditioner 73 including a conditioning path 75, and a belt conveyor 77 for conveying the cut plant material from the mower 71 to the conditioner 73. The conditioner 73 is of a similar construction to the conditioner 11 of the first embodiment.

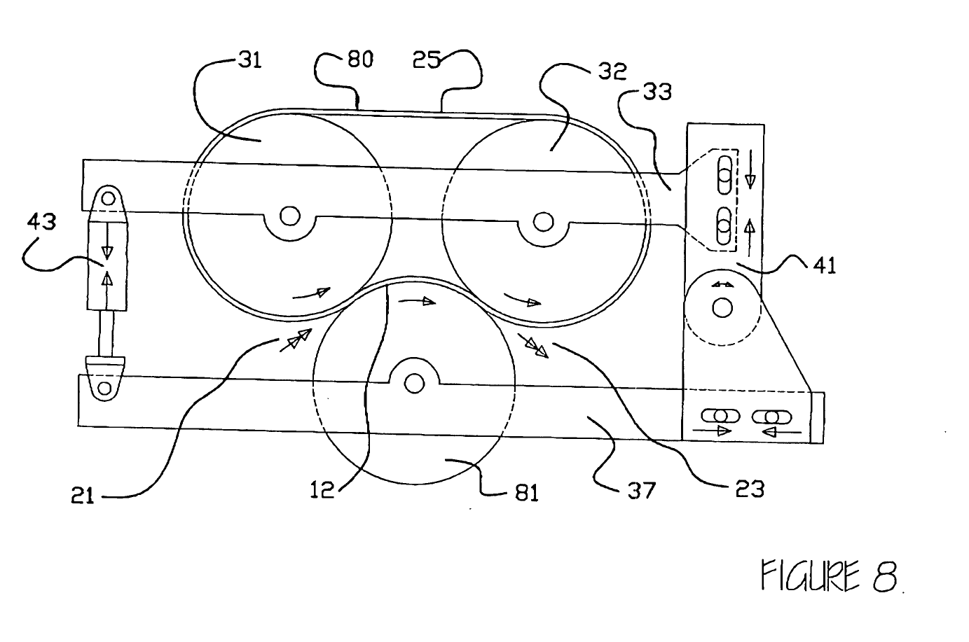

In each of the embodiments which have been described previously, the conditioning path 12 has been defined between two endless belts 25, 27. Other arrangements are, of course, possible. One such other arrangement is illustrated in FIG. 8 of the drawings where there is shown a conditioner 80 which is somewhat similar to the conditioner 11 and like reference numbers are used to identify corresponding parts, with the exception that the lower surface of the conditioning path 12 is defined by a roller 81 mounted on the lower beam 37. In this arrangement, the roller 81 is nestled between the two rollers 31, 32 around which the upper belt 25 travels.

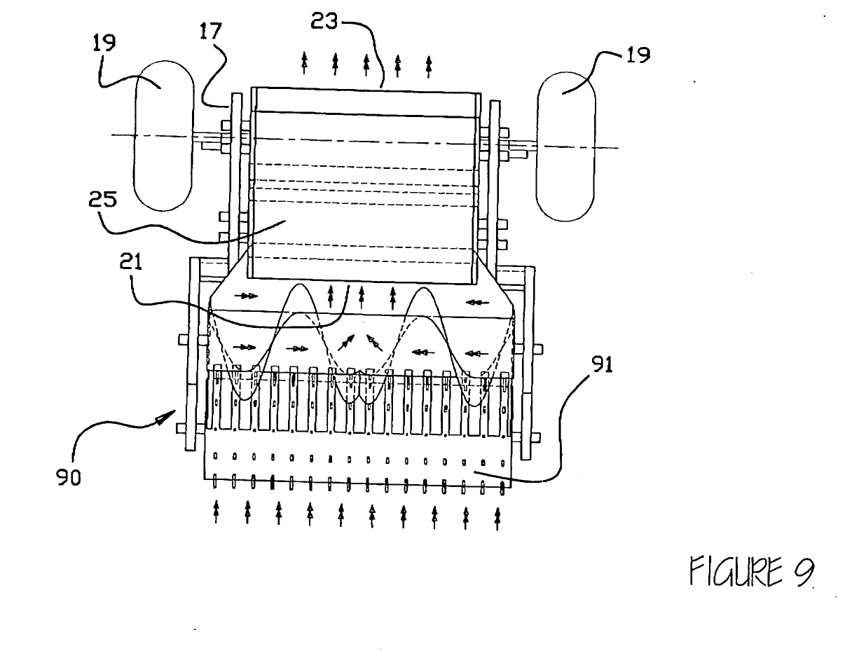

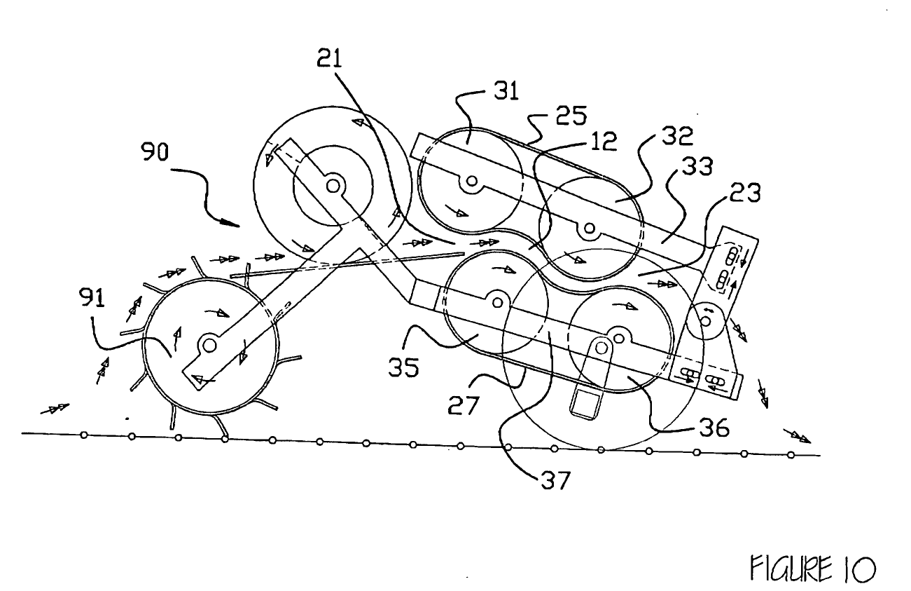

The apparatus according to several earlier embodiments incorporate a mower for cutting plant material from which hay is produced. Other arrangements are, of course, possible. For example, it is possible to provide a conditioning apparatus which operates independently of a mower and which is simply used to condition hay that has already been cut and is laying on the ground. One such apparatus is the subject of the embodiment shown in FIGS. 9 and 10 of the drawings. In this embodiment, the apparatus 90 includes an elevator system 91 for gathering hay laying on the ground and delivering it to the intake end 21 of the conditioning path 12. The material is subsequently conditioned and discharged through the discharge end 23 and returned to the ground.

In various embodiments described, the control means 43 comprised a hydraulic ram. It should be appreciated that other forms of control means may be utilised including, for example, pneumatic cylinders.

Pneumatic cylinders are advantageous in that they can yield to accommodate shock loadings without the need for an accumulator as required by hydraulic cylinders.

From the foregoing, it is evident that the present invention provides a simple yet highly effective arrangement for super-conditioning hay. The apparatus provides an extended conditioning path as compared to the prior aft arrangement where conditioning is performed by two rollers in line contact. This arrangement avoids the shock loadings present in such a prior art arrangement. Furthermore, the apparatus according to the present invention may have facility to permit a “easy entry” of the plant material into the conditioning path.

It should be appreciated that the scope of the invention is not limited to the scope of the embodiments described.

Throughout the specification, unless the context requires otherwise, the word “comprise” or variations such as “comprises” or “comprising”, will be understood to imply the inclusion of a stated integer or group of integers but not the exclusion of any other integer or group of integers.

1. Apparatus for conditioning plant material comprising a conditioning path through which plant material can be passed to be subjected to compression for fracturing the stalks thereof, the conditioning path having an intake end and a discharge end, the conditioning path being defined between two compression surfaces one of which is defined by an endless belt moveable through a cyclic path about rollers, the rollers being mounted on a common support, one compression surface being mounted for movement with respect to the other compression surface for varying the size of the intake end relative to the discharge end.

2. Apparatus according to claim 1 wherein the common support for the rollers comprises a beam which is angularly moveable, and wherein control means are provided for controlling angular movement of the beam.

3. Apparatus according to claim 2 wherein the other compression surface is defined by means supported on a further beam.

4. Apparatus according to claim 3 wherein the control means is operably connected between the two beams.

5. Apparatus according to claim 2 wherein the control means comprises a power device such as a hydraulic cylinder or a pneumatic cylinder.

6. Apparatus according to claim 5 wherein the power device is adapted for yieldingly resistive movement in response to a predetermined load being subjected thereto.

7. Apparatus according to claim 1 wherein the other compression surface is defined by a roller.

8. Apparatus according to claim 1 wherein the other compression surface is defined by a second endless belt moveable through a cyclic path about further rollers.

9. Apparatus according to claim 8 wherein each endless belt is movable around two end rollers and an intermediate roller, the intake end of the conditioning path being defined adjacent the two intermediate rollers, and wherein an intake zone leads to the intake end of the conditioning path, the intake zone being defined between the runs of the respective endless belts extending between the end rollers adjacent the intake end and the intermediate rollers.

10. Apparatus according to claim 9 wherein the intake zone tapers inwardly in the direction towards the intake end.

11. An agricultural machine incorporating apparatus according to claim 1.

12. A mower conditioner incorporating apparatus according to claim 1.

13. (Cancelled)
